(19) United States
(12) Patent Application Publication
(10) Pub. No.: US 2021/0244208 A1
(43) Pub. Date: Aug. 12, 2021

(54) WASHABLE WEIGHTED BLANKET HAVING BEADS AND NINE LAYERS

(71) Applicant: CAREY SUTTON, NEW YORK, NY (US)

(72) Inventor: CAREY SUTTON, New York, NY (US)

(21) Appl. No.: 16/787,374

(22) Filed: Feb. 11, 2020

(51) Int. Cl. A47G 9/02; B32B 27/12

(52) U.S. Cl. CPC A47G 9/0223; B32B 27/12; B32B 5/12; B32B 2305/18; B32B 2307/304

(57) ABSTRACT

The present invention provides a weighted blanket having multiple protective layers surrounding an internal layer of glass beads or ceramic beads or any type of beads having a first and uppermost layer made of any type of face fabric, such as cotton; a second internal layer is made of polyester batting fill or any type of fill, which provides a layer of extra comfort; a third internal layer is made of a protective layer of a fabric shell, such as polyester, or any type of material; a fourth internal layer is made of a layer of polyester batting fill or any type of fill; a fifth internal layer is made of glass beads or ceramic beads or any type of beads spaced apart from each other in separately spaced apart sewn pockets; a sixth internal layer is made of a layer of polyester batting fill or any type of fill; a seventh internal layer is made of a protective layer of a polyester fabric shell or any material; an eighth internal layer is made of polyester batting fill or any type of fill, which provides a layer of extra comfort; and a ninth and bottom most layer is made of any type of face fabric, such as cotton. In this manner, the present invention provides multiple advantages of increased comfort and being machine washable, and providing a protective shell and sewn pockets around the beads in its construction to prevent the leaking of the beads from the blanket, including the individual pockets to retain and hold the beads.

### FIELD OF THE INVENTION

The invention relates to a weighted blanket having multiple protective layers surrounding an internal layer of glass beads or ceramic beads or any type of beads, which includes a unique construction of layers having a protective fabric shell made of any material, such as polyester and polyester batting fill or any type of fill for comfort, with the internal glass beads or ceramic beads or any type of beads housed in protective pockets.

### BACKGROUND OF THE INVENTION

The popularity of weighted blankets is based on their usefulness to reduce anxiety and promote better sleep, and typically includes a blanket filled with small objects, such as pellets, disks, or beads made of different materials, such as plastic or glass, which provide added weight to the blanket causing it to gently hug the user. Weighted blankets for adults range from a weight of 10 to 30 pounds, and lighter weight blankets for children are also made.

The goal of the weighted blanket is to apply a soft and even-pressure to the user's body, which is made more effective when it snuggly fits the user's body.

Although weighted blankets can benefit anyone, they are especially useful for fitful sleepers, since the weighted blanket gently presses on the user, keeping the user still and supported through the entire sleeping cycle. Further, the soothing pressure provided by the weighted blanket is known to reduce cortisol, the human body's main stress hormone, and also encourages the production of serotonin, a hormone known to be associated with a person's feelings of happiness and well-being. In fact, according to one study, the “deep touch pressure” provided by the weighted blanket “gives subject's the feelings of safety, relaxation, and comfort.” In addition, weighted blankets are reported to lower anxiety, and alleviate symptoms in person's suffering from insomnia, chronic pain conditions, or restless leg syndrome. Weighted blankets are also reported to be beneficial for psychological reasons with potential benefits from person's suffering from depression or autism.

### DESCRIPTION OF THE PRIOR ART

However, there are some negative disadvantages in the use of weighted blankets, which include that most weighted blankets are not machine washable, and also have the disadvantage of the glass beads shifting around to provide a non-equal distribution of weight in the weighted blanket. Further, there is a problem of glass beads leaking from within the blanket if a tear in the blanket develops.

The present invention has been found to be advantageous for the following reasons: the method of production has been improved and has been expedited, so that the individual weighted blanket is produced more quickly. In addition, the present invention has been found to be advantageous in creating a weighted blanket that is machine washable, and uses in its construction a protective shell and protective pockets around the glass beads or ceramic beads or any type of beads to provide this advantage.

Further, the protective shell and the protective pockets around the glass beads or ceramic beads or any type of beads allows the weighted blanket of the present invention to prevent leaking of the beads from the blanket, which is a common problem with other weighted blankets. Finally, the construction of the present invention provides a more equal distribution of glass beads or ceramic beads or any type of beads within each of the internal pockets formed in the weighted blanket of the present invention.

### OBJECTS OF THE INVENTION

It is an object of the present invention to provide a weighted blanket having multiple protective layers surrounding an internal layer of glass beads or ceramic beads or any type of beads.

Another object of the present invention is to provide a weighted blanket having a unique construction of layers, including protective layers, such as polyester fabric, cotton polyester blended fabric, nylon fabric, or non-woven fabric.

Another object of the present invention is to provide a weighted blanket having a unique construction of layers, including comfort layers of polyester batting fill or any type of fill for comfort.

Another object of the present invention is to provide a weighted blanket having glass beads or ceramic beads or any type of beads housed in protective pockets within the weighted blanket.

Another object of the present invention is to provide a weighted blanket promoting improved sleep, a reduction in anxiety, and keeps the user still and supported during the entire sleeping cycle.

Another object of the present invention is to provide a weighted blanket that gently hugs the user and applies a soft and even pressure to the user's body and which snuggly fits the user's body by gently applying a soothing pressure to the user's body, which is known to reduce cortisol in the user's body, as well as increase the production of serotonin.

Another object of the present invention is to provide a weighted blanket provides the user with a feeling and safety, relaxation, and comfort, while alleviating symptoms of insomnia, and chronic pain conditions, such as restless leg syndrome.

Another object of the present invention is to provide a weighted blanket that is machine washable and includes protective layers and reinforced pockets around the beads in its construction.

### SUMMARY OF THE INVENTION

The present invention provides a weighted blanket having multiple protective layers surrounding an internal layer of glass beads or ceramic beads or any type of beads having a first and uppermost layer made of any type of face fabric, such as cotton; a second internal layer is made of polyester batting fill or any type of fill, which provides a layer of extra comfort; a third internal layer is made of a protective layer of a fabric shell, such as polyester or any type of material; a fourth internal layer is made of a layer of polyester batting fill or any type of fill; a fifth internal layer is made of glass beads or ceramic beads or any type of beads spaced apart from each other in separately spaced apart sewn pockets; a sixth internal layer is made of a layer of polyester batting fill or any type of fill; a seventh internal layer is made of a protective layer of a polyester fabric shell, such as polyester or any type of material; an eighth internal layer is made of polyester batting fill or any type of fill, which provides a layer of extra comfort; and a ninth and bottom most layer is made of any type of face fabric, such as cotton. In this manner, the present invention provides multiple advantages of increased comfort and being machine washable, and providing a protective shell and sewn pockets around the beads in its construction to prevent the leaking of the beads from the blanket, including the individual pockets to retain and hold the beads.

### BRIEF DESCRIPTION OF THE DRAWINGS

FIG. 1 is an exploded perspective view of the weighted blanket 10 of the present invention having nine layers 20, 30, 40, 50, 60, 70, 80, 90, and 100;

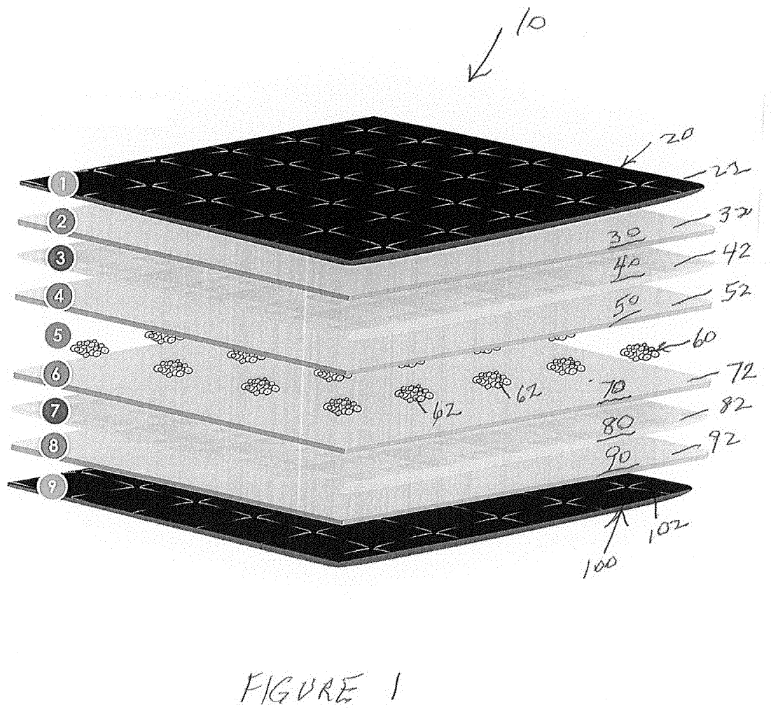

FIG. 2 is a top view of the middle or central layer 60 having a plurality of glass beads 62 or ceramic beads or any type of beads located in each sewn pocket 66, and the sewn stitch lines around each pocket of beads to prevent the beads 62 from moving or leaking out of the sewn pocket; and

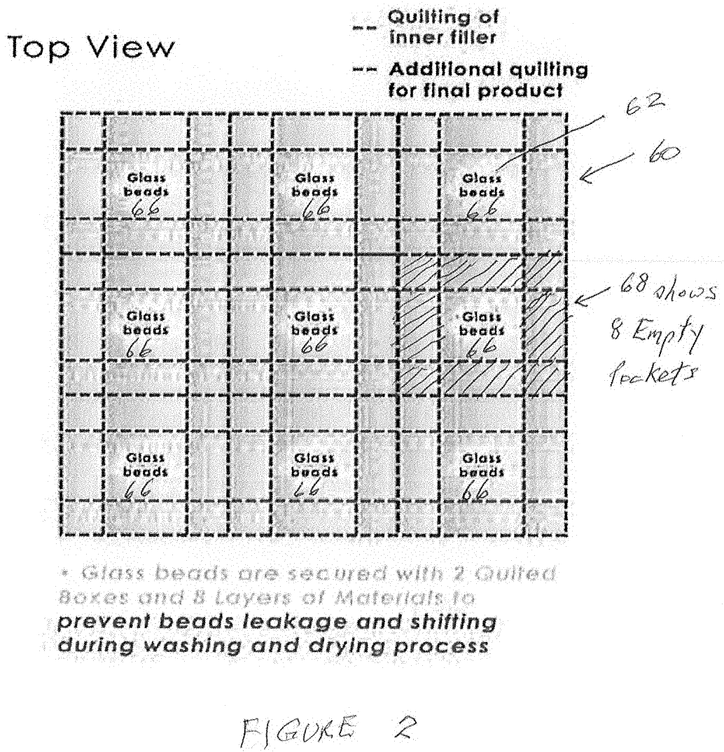

FIG. 3 is a perspective view of the five innermost layers of the weighted blanket 10, which are pre-made and pre-assembled first to form an inner pre-made internal filler 110, so that two outer layers 20 and 30 are then added to the top of the pre-made internal filler 110, and then two more outer layers 90 and 100 are then added to the bottom of the pre-made internal filler 110.

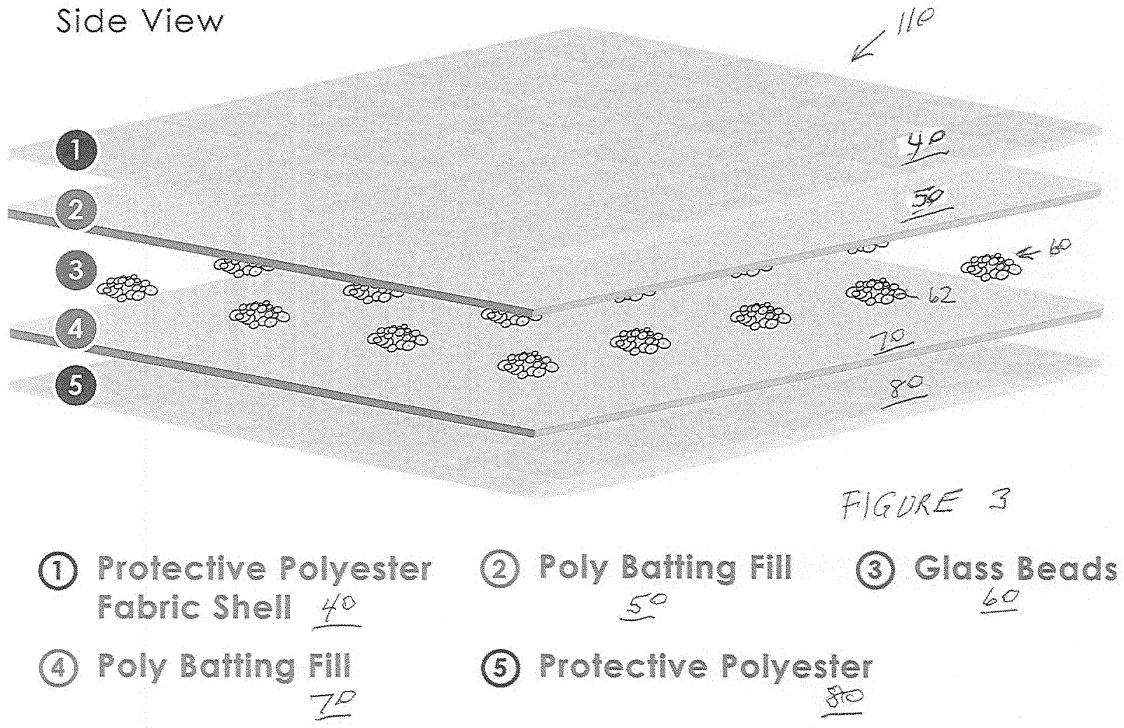

### DETAILED DESCRIPTION OF THE PREFERRED EMBODIMENT

The present invention provides the construction of a washable weighted blanket 10, which includes the following nine layers:
1) The first and uppermost layer 20 is made of any type of face fabric, such as polyester, cotton, nylon, or cotton polyester blend 22 having a weight of 90 grams per square meter (90 gsm).
2) The second internal layer 30 is made of any type of fill 32, such as polyester fill, cotton, or cotton polyester blend having a preferred weight of 50 grams per square meter (50 gsm), but can be any weight, such as 25 gsm, 70 gsm, or 100 gsm. This provides a layer of extra comfort and prevents bead leakage and movement.
3) The third internal layer 40 is a protective layer made of any type of fabric, such as polyester, cotton, nylon, or cotton polyester blend 42 having a weight of 50 grams per square meter (50 gsm).
4) The fourth internal layer 50 is made of a layer of any type of fill, such as polyester fill, cotton, or cotton polyester blend 52 having a preferred weight of 50 grams per square meter (50 gsm), but can be any weight, such as 25 gsm, 70 gsm, or 90 gsm. This provides a layer of extra comfort and prevents bead leakage and movement.
5) The fifth internal layer 60 is made of glass beads 62 or ceramic beads 62 or any type of beads spaced apart from each other in separately spaced apart sewn pockets 64; each pocket having a plurality of glass beads or ceramic beads or any type of beads.

Glass beads:
a. Preferred size range per bead: 0.8 to 1.0 mm
b. Larger size range per bead: 0.6 to 1.5 mm
c. Preferred weight of each pocket: 0.07 to 0.15 lb.
d. Larger weight of each pocket: 0.02 to 0.23 lb.

Ceramic Beads:
a. Preferred size range per bead: 0.8 to 2.0 mm
b. Larger size range per bead: 0.6 to 1.5 mm
c. Preferred weight of each pocket: 0.07 to 0.15 lb.
d. Larger weight of each pocket: 0.02 to 0.23 lb.

Pre-made inner layer (fifth internal layer 60) of weighted blanket:
a. Preferred pocket size range: 2.5 to 2.75 inches
b. Larger pocket size range: 2 to 6 inches

Pocket size of a completed weighted blanket having nine layers sewn together:
a. Preferred pocket size range: 5.0 to 6.0 inches
b. Larger pocket size range: 3.0 to 8.0 inches

In a blanket that is 4 feet by 6 feet, the fifth inner layer 60 has 17 pockets times 25 pockets, with a layer of beads that are filled in every other pocket (meaning that the pocket in between is empty). Preferably, there are 8 bead-filled pockets in the 4 foot length, and there are 12 bead-filled pockets along the 6 foot width. Therefore, there are 96 pockets filled with beads in total in the 4 foot by 6 foot blanket.

Therefore, there are 8 pockets in a 4 foot length, and 12 pockets in a 6 foot width, so that there are a total of 96 pockets.

Glass Beads:

Each glass bead is 0.8 to 1.0 mm in size, and each pocket 64 of glass beads has a preferred weight of 0.7 to 0.15 lbs. Therefore, in a blanket that is 48 inches by 72 inches in size, each pocket size in the fifth layer 60 is preferably 2½ inches by 2¾ inches in size, but the size may vary. Thus, there are 17 pockets times 25 pockets in the layer, so that there are 96 bead-filled pockets in layer 60. However, the weight of each pocket may vary between 0.07 lbs. to 0.15 lbs. Also, the size of each glass bead may vary between 0.6 mm to 1.5 mm, and the pocket size may vary between 2 inches and 6 inches. As a result, the total number of bead filled pockets may vary.

Glass beads are filled in every other pocket in a 4 foot length, and every other line in a 6 foot width. There are 8 glass bead-filled pockets in a 4 foot length, and 12 glass bead-filled pockets in a 6 foot width, so that there is a total of 96 glass bead-filled pockets in layer 60.

Ceramic Beads:

Each ceramic bead is 0.8 to 2.0 mm in size, and each pocket 64 of ceramic beads has a preferred weight of 0.7 to 0.15 lbs. Therefore, in a blanket that is 48 inches by 72 inches in size, each pocket size in the fifth layer 60 is preferably 2½ inches by 2¾ inches in size, but the size may vary. Thus, there are 17 pockets times 25 pockets in the layer, so that there are 96 ceramic bead-filled pockets in layer 60. However, the weight of each pocket may vary between 0.02 lbs. to 0.23 lbs. Also, the size of each ceramic bead may vary between 0.6 mm to 1.5 mm, and the pocket size may vary between 2 inches and 6 inches. As a result, the total number of bead filled pockets may vary.

Ceramic beads are filled in every other pocket in a 4 foot length, and every other line in a 6 foot width. There are 8 ceramic bead-filled pockets in a 4 foot length, and 12 ceramic bead-filled pockets in a 6 foot width, so that there is a total of 96 ceramic bead-filled pockets in layer 60.

Reinforced Pockets: The layers 20, 30, 40, 50, 70, 80, 90, and 100 surrounding the fifth layer 60 of beads provide additional layers of reinforcement sewing pocket 68 around each sewn pocket 66, which is around each pocket 64 of beads. The sewn pockets 66 act as reinforcement sewing for each pocket 64 of beads. The size of the outer reinforcement sewing pocket 68 around each sewn pocket 66 is 1⅝ inch to 1¾ inches on all sides of the pockets 66. Thus, there is a sewn pocket 68 of 6 inches by 6 inches in size, so that in a four foot length of blanket, there are 8 pockets 68, and in a 6 foot width of blanket, there are 12 pockets 68 for a total of 96 pockets 68. Also, the size of the reinforced pockets may vary.
6) The sixth internal layer 70 is made of a layer of any type of fill, such as polyester fill, cotton, or cotton polyester blend 72 having a preferred weight of 50 grams per square meter (50 gsm), but can be any weight, such as 25 gsm, 70 gsm, or 100 gsm. This provides a layer of extra comfort and prevents bead leakage and movement.
7) The seventh internal layer 80 is a protective layer made of any type of material, such as polyester, cotton, nylon, or cotton polyester blend 82 having a weight of 50 grams per square meter (50 gsm).
8) The eighth internal layer 90 is made of a layer of any type of fill, such as polyester fill, cotton, or cotton polyester blend 92 having a preferred weight of 50 grams per square meter (50 gsm), but can be any weight, such as 25 gsm, 70 gsm, or 100 gsm. This provides a layer of extra comfort and prevents bead leakage and movement.
9) The ninth and bottom most layer 100 made of any type of face fabric, such as polyester, cotton, nylon, or cotton polyester blend 102 having a weight of 90 grams per square meter (90 gsm).

Therefore, during manufacture, the first, second, eighth, and ninth outermost layers are added to the inner layers three through seven, and these inner layers have empty pockets. In this manner, these additional outer layers first, second, eighth, and ninth create extra reinforcement of the pockets in the fifth middle layer 60.

During manufacture, the foregoing outer layers are added to the inner layers, in sequence, in order to make the entire combination of nine layers to produce weighted blanket 10.

The blankets may vary in size from 24 inches by 24 inches up to 48 inches by 72 inches, and other sizes may be made.

Further, the weighted blanket 10 of the present invention typically may have a weight of 12 lbs., 15 lbs., 18 lbs., or 20 lbs., or any weight, in a blanket that is 4 feet by 6 feet, and the weight of the blanket may vary for different sized blankets. In addition, the fabric may be made of microfiber or mink or a combination or microfiber and mink, or any other fabric.

### Operation

In operation, in the preferred embodiment, the five innermost layers 40, 50, 60, 70, and 80 are pre-made and pre-assembled first to form the inner pre-made filler layers 110 to be used as an internal filler 110 in the manufacturing process.

Then, the outer upper layers 20 and 30 are added to the top of the pre-made inner filler 110. Thereafter, lower outer layers 90 and 100 are added to the bottom of inner filler 110 to thereby form the weighted blanket 10. In this manner, blanket 10 is produced more quickly and economically.

In addition, in making the internal layer 60, the glass beads or ceramic beads or any type of beads 62 are placed apart from each other on layer 60 as described above. Also, a square pocket, or circular pocket, or any other shaped pocket, is stitched around each pocket of beads, as reinforcement. The first reinforced sewing 66 around each bead pocket 64 prevents the beads 62 from moving or leaking outside of their respective pockets, or from moving or leaking throughout the surface of the blanket. The second reinforced sewing 68 is larger and surrounds sewing 66 around each bead pocket 64 to prevent the beads 62 from moving or leaking outside of their respective pockets, or from moving or leaking throughout the surface of the blanket. In this manner, the glass beads or ceramic beads or any type of beads 62 are securely held in place by two reinforced sewing stitches 66 and 68 around each pocket location 64 on the blanket 10.

Therefore, the reinforcement sewn pockets 66 and 68 are created, when they are stitched in the surrounding outer upper layers 20, 30, 40, and 50 on one side of layer 60, and when they are stitched in the surrounding outer lower layers 70, 80, 90, and 100, so that all of these layers are sewn together to reinforce the lines of stitching 66 and 68 around each pocket of beads.

The crossed stitch lines of pockets 66 and pockets 68 create an additional 8 small empty pockets (having no beads) around each pocket 66. These additional 8 small pockets 68 help limit bead movement within small areas.

The shape of pockets 66, 68 and the 8 small pockets may be square or circular or any shape. The total number of pockets 66, 68 and the 8 small pockets may vary.

### Advantages of the Present Invention

It is an advantage of the present invention to provide a weighted blanket having multiple protective layers surrounding an internal layer of glass beads or ceramic beads or any type of beads.

Another advantage of the present invention is to provide a weighted blanket having a unique construction of layers, including protective layers made of any type of material, such as polyester fabric, cotton polyester blended fabric, nylon fabric, or non-woven fabric.

Another advantage of the present invention is to provide a weighted blanket having a unique construction of layers, including comfort layers of polyester batting fill or any type of fill for comfort.

Another advantage of the present invention is to provide a weighted blanket having glass beads or ceramic beads or any type of beads housed in protective pockets within the weighted blanket.

Another advantage of the present invention is to provide a weighted blanket promoting improved sleep, a reduction in anxiety, and keeps the user still and supported during the entire sleeping cycle.

Another advantage of the present invention is to provide a weighted blanket that gently hugs the user and applies a soft and even pressure to the user's body and which snuggly fits the user's body by gently applying a soothing pressure to the user's body, which is known to reduce cortisol in the user's body, as well as increase the production of serotonin.

Another advantage of the present invention is to provide a weighted blanket provides the user with a feeling and safety, relaxation, and comfort, while alleviating symptoms of insomnia, and chronic pain conditions, such as restless leg syndrome.

Another advantage of the present invention is to provide a weighted blanket that is machine washable and includes protective layers and reinforced pockets around the beads in its construction.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1) A weighted blanket (10) having multiple protective layers surrounding an internal layer of glass beads or ceramic beads or any type of beads, comprising the following:
a) said first and uppermost layer (20) is made of any type of face fabric, such as polyester, cotton, nylon, or cotton polyester blend (22) having a weight of 90 grams per square meter (90 gsm);
b) said second internal layer (30) is made of any type of fill, such as polyester fill, cotton, or cotton polyester blend (32) having a preferred weight of 50 grams per square meter (50 gsm), but may be 25 gsm, 70 gsm, or 100 gsm to provide a layer of extra comfort and prevents bead leakage and movement;
c) said third internal layer (40) is a protective layer made of an inner fabric made of any type of fabric, such as polyester, cotton, nylon, or cotton polyester blend (42) having a weight of 50 grams per square meter (50 gsm);
d) said fourth internal layer (50) is made of a layer of any type of fill, such as polyester fill, cotton, or cotton polyester blend (52) having a preferred weight of 50 grams per square meter (50 gsm), but may be 25 gsm, 70 gsm, or 100 gsm to provide a layer of extra comfort and prevents bead leakage and movement;
e) said fifth internal layer (60) is made of glass beads (62) or ceramic beads (62) spaced apart from each other in separately spaced apart sewn pockets (64); each pocket having a plurality of glass beads or ceramic beads or any type of beads, wherein said glass beads have:
a. Preferred size range per bead: 0.8 to 1.0 mm
b. Larger size range per bead: 0.6 to 1.5 mm
c. Preferred weight of each pocket: 0.07 to 0.15 lb.
d. Larger weight of each pocket: 0.02 to 0.23 lb.
wherein said ceramic beads have:
a. Preferred size range per bead: 0.8 to 2.0 mm
b. Larger size range per bead: 0.6 to 1.5 mm
c. Preferred weight of each pocket: 0.07 to 0.15 lb.
d. Larger weight of each pocket: 0.02 to 0.23 lb.
wherein said fifth internal layer (60) of weighted blanket (10) has a:
a. Preferred pocket size range: 2.5 to 2.75 inches
b. Larger pocket size range: 2 to 6 inches
f) said sixth internal layer (70) is made of a layer of any type of fill, such as polyester fill, cotton, or cotton polyester blend (72) having a preferred weight of 50 grams per square meter (50 gsm), but may be 25 gsm, 70 gsm, or 100 gsm to provide a layer of extra comfort and prevents bead leakage and movement;
g) said seventh internal layer (80) is a protective layer made of any type of material, such as polyester, cotton, nylon, or cotton polyester blend (82) having a weight of 50 grams per square meter (50 gsm);
h) said eighth internal layer (90) is made of a layer of any type of fill, such as polyester fill, cotton, or cotton polyester blend (92) having a preferred weight of 50 grams per square meter (50 gsm), but may be 25 gsm, 70 gsm, or 100 gsm to provide a layer of extra comfort and prevents bead leakage and movement;
i) said ninth and bottom most layer (100) is made of any type of face fabric, such as polyester, cotton, nylon, or cotton polyester blend (102) having a weight of 90 grams per square meter (90 gsm);
j) said first layer (20), second layer (30), third layer (40), fourth layer (50), said sixth layer (70), said seventh layer (80), eighth layer (90), and ninth layer (100) surrounding said fifth layer (60) of beads provide additional layers of reinforcement sewn pockets (66) and (68) around each pocket of beads (64) to act as reinforcement sewing for each pocket of beads; and
k) said cross stitch lines of pockets (66) and pockets (68) create an additional 8 empty pockets around pockets 66; said additional 8 small pockets (68) help limit bead movement within small areas.

2) A weighted blanket in accordance with claim 1, wherein spaced apart sewn pocket (64) is stitched in a square pocket, or a circular pocket, or any other pocket shape around the embedded beads (62) in each of said pockets, so that the sewn pockets prevent the beads from moving or leaking outside their respective pockets or throughout the surface of the blanket.

3) A weighted blanket in accordance with claim 1, wherein said five innermost layers (40), (50), (60), (70), and (80) are pre-made and pre-assembled first to form said inner pre-made filler (110) to be used as an internal filler (110) in said manufacturing process.

4) A weighted blanket in accordance with claim 4, wherein said first layer (20) and said second layer (30) are added to the top of said pre-made inner filler (110), and wherein said eighth layer (90) and ninth layer (100) are added to said bottom of the pre-made filler (110), to thereby form all layers of the weighted blanket (10).

5) A weighted blanket having multiple protective layers surrounding an internal layer of glass beads and ceramic beads, comprising the following:
a) said first and uppermost layer (20) is made of any type of face fabric, such as polyester, cotton, nylon, or cotton polyester blend 22 having a weight of 90 grams per square meter (90 gsm);
b) said second internal layer (30) is made of any type of fill, such as polyester fill, cotton, or cotton polyester blend (32) having a preferred weight of 50 grams per square meter (50 gsm), but may be 25 gsm, 70 gsm, or 100 gsm to provide a layer of extra comfort and prevents bead leakage and movement;
c) said third internal layer (40) is a protective layer of an inner fabric made of any type of fabric, such as polyester, cotton, nylon, or cotton polyester blend (42), or any other type of material, having a weight of 50 grams per square meter (50 gsm);
d) said fourth internal layer (50) is made of a layer of any type of fill, such as polyester fill, cotton, or cotton polyester blend (52) having a preferred weight of 50 grams per square meter (50 gsm), but may be 25 gsm, 70 gsm, or 100 gsm to provide a layer of extra comfort and prevents bead leakage and movement;
e) said fifth internal layer (60) is made of glass beads or ceramic beads or any type of beads (62) spaced apart from each other in separately spaced apart sewn pockets (64); each pocket having a plurality of glass beads or ceramic beads or any type of beads, wherein each glass bead is 0.8 to 1 m in size, and wherein each ceramic bead is 0.8 to 2.0 mm, and each pocket (64) of glass beads or ceramic beads or any type of beads has a weight in the range of 0.07 lbs. to 0.15 lbs.;
f) said sixth internal layer (70) is made of a layer of any type of fill, such as polyester fill, cotton, or cotton polyester blend (72) having a preferred weight of 50 grams per square meter (50 gsm), but may be 25 gsm, 70 gsm, or 100 gsm to provide a layer of extra comfort and prevents bead leakage and movement;
g) said seventh internal layer (80) is a protective layer made of any type of material, such as polyester, cotton, nylon, or cotton polyester blend (82), or any other type of material, having a weight of 50 grams per square meter (50 gsm);
h) said eighth internal layer (90) is made of a layer of any type of fill, such as polyester fill, cotton, or cotton polyester blend (92) having a preferred weight of 50 grams per square meter (50 gsm), but may be 25 gsm, 70 gsm, or 100 gsm to provide a layer of extra comfort and prevents bead leakage and movement;
i) said ninth and bottom most layer (100) is made of any type of face fabric, such as polyester, cotton, nylon, or cotton polyester blend (102), such as polyester, having a weight of 90 grams per square meter (90 gsm); and
j) said layers (20), (30), (40), (50), (70), (80), (90), and (100) surrounding said fifth layer (60) of beads provide additional layers of reinforcement sewn pockets (66) and (68) around each pocket of beads (64) to act as reinforcement sewing for each pocket of beads; and
k) said cross stitch lines of pockets (66) and pockets (68) form an additional 8 small empty pockets around pockets 66; said additional 8 small pockets (68) help limit bead movement within small areas.

6) A weighted blanket in accordance with claim 5, wherein spaced apart sewn pocket (64) is stitched in a square pocket, or in a circular pocket, or any other pocket shape around the embedded beads (62) in each of said pockets, so that the sewn pockets prevent the beads from moving outside their respective pockets or throughout the surface of the blanket.

7) A weighted blanket in accordance with claim 5, wherein said five innermost layers (40), (50), (60), (70), and (80) are pre-made and pre-assembled first to form said inner pre-made filler (110) to be used as an internal filler (110) in said manufacturing process.

8) A weighted blanket in accordance with claim 7, wherein said first layer (20) and said second layer (30) are added to the top of said pre-made inner filler (110), and wherein said eighth layer (90) and ninth layer (100) are added to said bottom of the pre-made filler (110), to thereby form all layers of the weighted blanket (10).

9) A weighted blanket having multiple protective layers surrounding an internal layer of glass beads and ceramic beads, comprising the following:
a) said first and uppermost layer (20) is made of any type of face fabric, such as polyester, cotton, nylon, or cotton polyester blend 22 having a weight of 90 grams per square meter (90 gsm);
b) said internal layer (40) is a protective layer of an inner fabric made of any type of fabric, such as polyester, cotton, nylon, or cotton polyester blend (42), or any other type of material, having a weight of 50 grams per square meter (50 gsm);
c) said internal layer (50) is made of a layer of any type of fill, such as polyester fill, cotton, or cotton polyester blend (52) having a preferred weight of 50 grams per square meter (50 gsm), but may be 25 gsm, 70 gsm, or 100 gsm to provide a layer of extra comfort and prevents bead leakage and movement;
d) said internal layer (60) is made of glass beads or ceramic beads or any type of beads (62) spaced apart from each other in separately spaced apart sewn pockets (64); each pocket having a plurality of glass beads or ceramic beads or any type of beads, wherein each glass bead is 0.8 to 1 m in size, and wherein each ceramic bead is 0.8 to 2.0 mm, and each pocket (64) of glass beads or ceramic beads or any type of beads has a weight in the range of 0.07 lbs. to 0.15 lbs.;
e) said internal layer (70) is made of a layer of any type of fill, such as polyester fill, cotton, or cotton polyester blend (72) having a preferred weight of 50 grams per square meter (50 gsm), but may be 25 gsm, 70 gsm, or 100 gsm to provide a layer of extra comfort and prevents bead leakage and movement;
f) said internal layer (80) is a protective layer made of any type of material, such as polyester, cotton, nylon, or cotton polyester blend (82), or any other type of material, having a weight of 50 grams per square meter (50 gsm); and
g) said outer layer (100) is made of any type of face fabric, such as polyester, cotton, or cotton polyester blend (102) having a weight of 90 grams per square meter (90 gsm).
